(19) United States
(12) Patent Application Publication
(10) Pub. No.: US 2008/0063000 A1
(43) Pub. Date: Mar. 13, 2008

(54) Device and a Method for Exchanging Information Between a Bridge and a Device

(76) Inventors: Gadi Shor, Tel-Avive (IL); Yaron Knobel, Givat Shmuel (IL); Haim Kupershmidt, Or-Yehuda (IL)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/531,192

(22) Filed: Sep. 12, 2006

(51) Int. Cl. H04L 12/56; H04L 12/43

(52) U.S. Cl. 370/401; 370/458

(57) ABSTRACT

A device and method for exchanging information between an ultra wideband device and a bridge over a wireless medium. The ultra wideband device determines expected downstream transmission parameters; requests the bridge to allocate multiple downstream timeslots in response to the expected downstream transmission parameters; receives downstream timeslot acknowledgement information indicative of downstream timeslots assigned for a transmission of downstream information to the device; and receives downstream information during the assigned downstream timeslots.

### FIELD OF THE INVENTION

The invention relates to a device and a method for exchanging information between a bridge and a device.

### BACKGROUND OF THE INVENTION

Recent developments in telecommunication and semiconductor technologies facilitate the transfer of growing amounts of information over wireless networks. The demand for short to medium range, high-speed connectivity for multiple digital devices in a local environment continues to rise sharply. For example, many workplaces and households today have many digital computing or entertainment devices such as desktop and laptop computers, television sets and other audio and video devices, DVD players, cameras, camcorders, projectors, handhelds, and others. Multiple computers and television sets, for instance, have become common in American households. In addition, the need for high-speed connectivity with respect to such devices is becoming more and more important. These trends will inevitably increase even in the near future.

As the demand for high-speed connectivity increases along with the number of digital devices in typical households and workplaces, the demand for wireless connectivity naturally grows commensurately. High-speed wiring running to many devices can be expensive, awkward, impractical and inconvenient. High-speed wireless connectivity, on the other hand, offers many practical and aesthetic advantages, which accounts the great and increasing demand for it. Ideally, wireless connectivity in a local environment should provide high reliability, low cost, low interference caused by physical barriers such as walls or by co-existing wireless signals, security, and high-speed data transfer for multiple digital devices. Existing narrowband wireless connectivity techniques do not provide such a solution, having problems such as high cost, unsatisfactory data transfer rates, unsatisfactory freedom from signal and obstacle related interference, unsatisfactory security, and other shortcomings. In fact, the state of the art does not provide a sufficiently satisfactory solution for providing high-speed wireless connectivity for multiple digital devices in a local environment.

The state of the art in wireless connectivity generally includes utilization of spread spectrum systems for various applications. Spread spectrum techniques, which spread a signal over a broad range of frequencies, are known to provide high resistance against signal blocking, or “jamming,” high security or resistance against “eavesdropping,” and high interference resistance. Spread Spectrum techniques have been used in systems in which high security and freedom from tampering is required. Additionally, Code Division Multiple Access (CDMA), a spread spectrum, packet-based technique, is used in some cellular phone systems, providing increased capacity in part by allowing multiple simultaneous conversation signals to share the same frequencies at the same time.

Short-range ultra wide band wireless networks are being developed in order to allow wireless transmission of vast amounts of information between various devices. U.S. patent application 2003/0063597 of Suzuki, titled “Wireless transmission system, wireless transmission method, wireless reception method, transmitting apparatus and receiving apparatus”, which is incorporated herein by reference, described wireless networks that each includes a base station. U.S. patent application 2004/0170217 of Ho titled “Wireless personal area networks with rotation of frequency hopping sequences” describes a multiple piconets (personal network) environment in which each piconets is controlled by a piconets coordinator. Non-related and non-synchronized piconets use rotating frequency hopping sequences in order to avoid interferences.

Standard ECMA-368 “High Rate Ultra Wideband PHY and MAC standard”, first edition, December 2005, and standard ECMA-369 “MAC-PHY Interface for ECMA-368”, first edition, December 2005, which are also incorporated herein by reference, define the PHY and MAC layers for ultra wideband wireless networks.

Some of short-range ultra wide band wireless networks are characterized by a distributed architecture in which devices exchange information without being controlled by a central host or a base station.

Typically, ultra wideband devices such as transmitters and receivers (also referred to as transceivers) share the wireless medium by applying a media access control mechanism that determines which device can transmit over the shared wireless medium.

A device that requests to transmit information can request to reserve (in advance) one or more time slots using the distributed reservation protocol (DRP) mechanism or can compete with other transmitting devices by using the prioritized contention access (PCA) mechanism. In both mechanisms a device can only request to transmit information to other devices.

In addition the media access mechanism also requires devices to transmit beacon slots that are used to synchronize devices. A typical beacon frame includes information that identifies the Distributed Reservation Protocol (DRP) time slots reserved by the device for communication with its peers. A device which is the source of information (the transmitter) is the entity that initiates the DRP negotiation, and is called the “owner” of the reservation.

DRP slots are coordinated between devices that belong to the same network and allow devices to reserve these slots in advance. This scheme is usually utilized for applications with high Quality of Service (QoS) requirements. During PCA slots devices that belong to the network compete for access based upon their transmission priority. It is noted that the allocation of media access time slots is dynamic and may change from one TDMA frame to another.

Typically, transmissions from devices during PCA slots are assigned by applying a carrier sense multiple access with collision avoidance (CSMA/CA) scheme. In this scheme, if a device requests to transmit over a wireless medium, it has to check if the wireless medium is idle. If the medium is indeed idle, the device has to wait a random backoff period. This random backoff time is selected from a contention window that has a length that is related to the priority of the device. For higher-priority devices the contention window is shorter.

A typical media access controller includes a controller or mapper that is connected to multiple PCA and DRP queues that can be characterized by different priorities. The controller assigns information frames provided by various applications to the PCA and DRP queues according to the type of application, and the like. Typically, DRP slots are used to convey isochronous traffic while PCA slots are used to convey asynchronous traffic. Multiple PCA queues can be connected to an access unit that applies a CSMA/CA scheme to schedule the transmission of information frames from these queues. The information frames are sent to a PHY layer that in turn generates and transmits electromagnetic signals representative of these information frames. The CSMA/CA scheme with differential access parameters is responsible for the PCA transmission priorities of the different PCA queues.

Ultra wideband transmission can be utilized for exchanging information between wireless devices as well as hybrid (wireless and wired) device. A bridge is expected to exchange information between a device to another device. U.S. Pat. No. 7,046,618 of Sendoff et al., PCT patent application publication number WO 2005/1055439A2 of Sendoff et al., all being incorporated herein by reference illustrate an ultra wideband bridge.

In prior art devices and methods only the information source device can establish a DRP reservation. A layer two bridge is a transparent device, and thus cannot perform DRP reservations. An alternative to a layer two bridge includes using a bridge having complex layer three functionality. Since there is a very large variety of layer three protocols, the bridge may not be able to support all layer three devices, thus limiting the possible applications that should be able to run over it.

There is a need to provide efficient devices, bridges and communication methods.

### SUMMARY OF THE INVENTION

In one embodiment, information is exchanged between an ultra wideband device and a bridge over a wireless medium. The ultra wideband device determines expected downstream transmission parameters; requests the bridge to allocate multiple downstream timeslots in response to the expected downstream transmission parameters; receives downstream timeslot acknowledgement information indicating downstream timeslots assigned for a transmission of downstream information to the device; and receives downstream information during the assigned downstream timeslots.

### BRIEF DESCRIPTION OF THE DRAWINGS

The present invention will be understood and appreciated more fully from the following detailed description taken in conjunction with the drawings in which:

FIG. 1 is a schematic illustration of a network, according to an embodiment of the invention;

FIG. 2 illustrates two devices and a bridge, according to an embodiment of the invention;

FIG. 3 is a logical illustration of various communication layers supported by a device and a bridge, according to an embodiment of the invention;

FIG. 4 illustrates a device according to an embodiment of the invention;

FIG. 5 illustrates a device according to another embodiment of the invention;

FIG. 6 is a flow chart of a method, according to an embodiment of the invention; and

FIG. 7 is a flow chart of a method, according to an embodiment of the invention.

### DETAILED DESCRIPTION OF THE DRAWINGS

Some portions of the following description relate to wireless ultra wide band networks that utilize a distributed media access control scheme. In these networks there is no central media access controller, but rather various devices of the network participate in determining how to share a common wireless medium. It is noted that according to various embodiments of the invention the disclosed methods and devices can be applied in networks that utilize a distributed media access control scheme but differ from ultra wide band wireless networks. It is further noted that according to some embodiments of the invention networks other than ultra wide band network can apply some of the suggested methods.

Various operations such as transmissions utilize the distributed media access control scheme in the sense that the access to a shared medium is governed by a distributed media access control scheme.

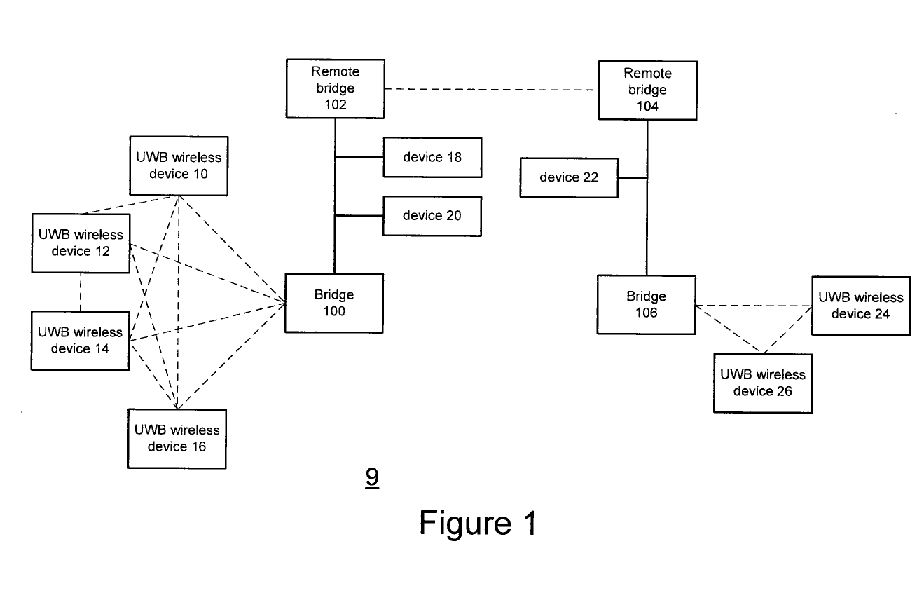

Some embodiments of the invention provide an ultra wide band wireless medium access control method and a device capable of performing ultra wide band wireless medium access control schemes. FIG. 1 illustrates network 9 according to an embodiment of the invention. For simplicity of explanation it is assumed that the network includes hybrid devices that communicate by using an Ethernet, or Ethernet-like protocol (for example, any 802.x compliant protocol). It is noted that other communication protocols can be used and that the number of devices per network as well as the type of each device can alter without departing from the scope of the invention.

Network 9 includes ultra wideband (UWB) wireless devices 10, 12, 14, 16, 24 and 26, bridges 100 and 106, remote bridges 102 and 104 and wired devices 18, 20 and 22. A remote bridge is connected to another remote bridge via wireless connection. Typically, a remote bridge can also have “regular” bridge capabilities that enable it to be connected to other devices (as well as bridges) via wired connections. WUB wireless devices 10-16 can wirelessly communicate with each other and can also communicate with bridge 100. WUB wireless devices 24 and 26 can wirelessly communicate with each other and can also communicate with bridge 106. Remote bridges 104 and 106 can wirelessly communicate with each other. Remote bridge 102 and bridge 100 can communicate, via wired link or network, with each other and with devices 18 and 20. A single device can have both remote bridge and bridge capabilities. For simplicity of explanation only the remote bridge is illustrated. Such a device can communicate over wired links with other devices or bridges and also wirelessly communicate with other remote bridges and devices

Conveniently, each one of bridge 100, bridge 106 can reserve one or more DRP timeslots for downstream transmission of information to a UWB device also referred to as WiNet device), wherein the UWB device triggers this reservation.

Conveniently, a UWB wireless device such as device 10 can determine transmission parameters of a downstream transmission from bridge 100 towards device 10 and then send to bridge 100 a request to allocate one or more timeslots for that transmission. Bridge 100 and devices 10-16 can participate in a distributed MAC scheme for determining the utilization of the wireless medium over which the devices and bridge communicate. Various distributed MAC schemes as well as other UWB techniques that can be implemented by devices 10-16 are illustrated in the following U.S. patent applications all being incorporated herein by reference: U.S. patent application Ser. No. 11/043,279 titled “Method and devices for multicasting information over a network that applies a distributed media access control scheme”; U.S. patent application Ser. No. 11/043,476 titled “Methods and devices for expanding the range of a network”; U.S. patent application Ser. No. 11/043,457 titled “A device and method for mapping information streams to MAC”; U.S. patent application Ser. No. 11/043,646 titled “Ultra wideband wireless medium access control method and a device for applying an ultra wideband wireless medium access control scheme”; U.S. patent application Ser. No. 11/043,456 titled “Method and device for transmission and reception over a distributed media access control network” and PCT patent application serial number PCT/IL2005/000021 titled “Distributed and centralized media access control device and method”.

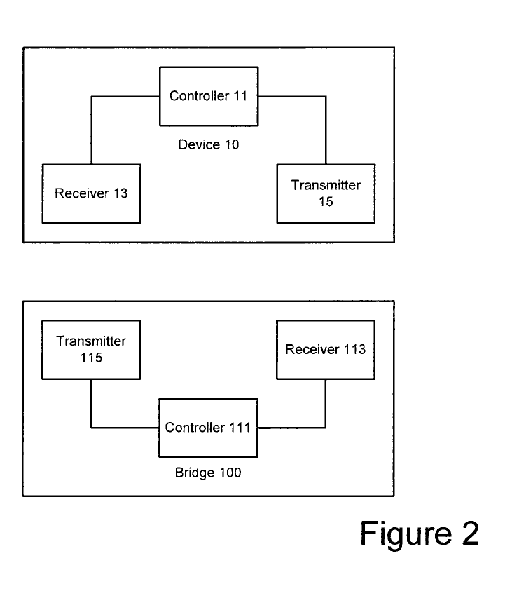

FIG. 2 illustrates device 10 and bridge 100, according to an embodiment of the invention.

Device 10 includes controller 11, receiver 13 and transmitter 15. Conveniently, many components of transmitter 15 and receiver 13 are shared, but this is not necessarily so. Controller 11 is connected to receiver 13 and transmitter 15 and can control their operation, but this is not necessarily so.

Controller 11 is adapted to determine expected downstream transmission parameters. These parameters can relate to expected quality of service level associated with the transmission. These expected downstream transmission parameters can include, for example, transmission parameters that comprise filtering parameters for filtering downstream information to be provided to the device. These filtering parameters can include (i) multiple filter parameters defining multiple filters, (ii) filter length, (iii) location of filtered field in a frame, (iv) expected value of filtered field and (v) filter mask value.

Conveniently, controller 11 is adapted to convert high communication layer quality of service characteristics to the expected media access control downstream transmission parameters. These high communication layers can include layer three, layer four and even higher communication layers.

Conveniently, using bridge media access control downstream transmission parameters to bridge 100 greatly simplifies bridge 100 that is not required to manage transmission parameters of higher communication protocols, especially in an environment where different device can use different higher layer communication protocols.

Device 10 is adapted to request a bridge to allocate multiple downstream timeslots in response to the expected downstream transmission parameters. The request can be prepared by controller 11 and transmitted by transmitter 15. It is noted that a bridge can be requested to reserve bandwidth by providing quality of service characteristics or by indicating which DRP slot reservations are required.

Receiver 13 is adapted to receive downstream timeslot reservation information indicating of downstream timeslots the bridge assigned for a transmission of downstream information to the device as a response to the request made by the device, and to receive downstream information during the assigned downstream timeslots.

Receive downstream timeslot reservation information can be provided to controller 11. The received downstream information during the assigned downstream timeslots can be processed by controller 11, but this is not necessarily so.

Conveniently, a request to receive bandwidth allocation can be sent if the bridge can service the request. Thus, device 10 can generate the request if it receives, from the bridge, bridge capability indication indicating that the bridge is capable of allocating downstream timeslot in response to a request from the device.

Bridge 100 includes controller 111, receiver 113 and transmitter 115. Conveniently, many components of transmitter 115 and receiver 113 are shared, but this is not necessarily so. Controller 111 is connected to receiver 113 and transmitter 115 and can control their operation, but this is not necessarily so.

Receiver 113 is adapted to receive a request to allocate multiple downstream timeslots for downstream transmission from the bridge to the device that is characterized by expected downstream transmission parameters. The downstream transmission parameters can relate to various layers including but not limited to media access control layer as well as higher communication layers.

Controller 111 is adapted to schedule downstream timeslots in response to the request. Conveniently, controller 111 is adapted to participate in a distributed media access control scheme in order to schedule the downstream timeslots. Conveniently, controller 111 is adapted to filter information that is downstream transmitted to the device in response to filtering parameters received by receiver 113.

Transmitter 115 is adapted to transmit to the device a DRP reservation request including time slots assigned for a transmission of downstream information to the device and, after DRP reservation is established, to transmit to the device downstream information during the assigned downstream timeslots. Conveniently, transmitter 115 is adapted to transmit to the device bridge capability indication indicating that bridge 100 is capable of allocating downstream timeslot in response to a request from the device.

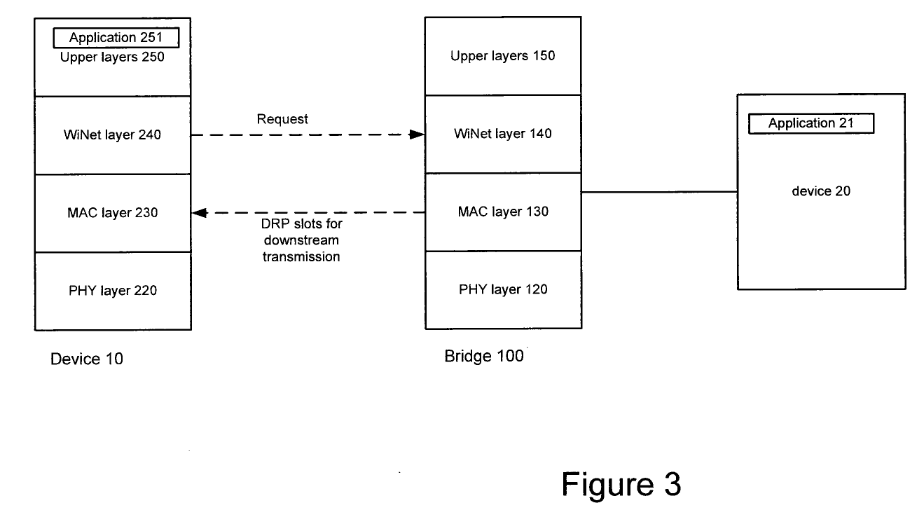

FIG. 3 is a logical illustration of various communication layers supported by device 10 and bridge 100, according to an embodiment of the invention. Bridge 100 is connected to device 20 by wire and is wirelessly connected to device 10. Device 10 can execute application 251 while device 20 executed application 21.

Device 10 supports PHY layer 220, a data link layer that includes MAC layer 230, and a logical link control sub-layer (denoted WiNet) 240, as well as upper layer protocols collectively denoted upper layers 250. The upper layers can include a network layer, a transport layer, a session layer and a presentation layer but this is not necessarily so. Upper layers 250 can represent some of the functionalities of controller 11.

Bridge 100 supports PHY layer 120, a data link layer that includes MAC layer 130, and a logical link control sub-layer (denoted WiNet) 140, as well as upper layer protocols collectively denoted upper layers 150. The upper layers can include a network layer, a transport layer, a session layer and a presentation layer but this is not necessarily so. Upper layers 150 can represent some of the functionalities of controller 11.

The request to allocate multiple downstream timeslots is logically sent from WiNet sub-layer 240 to WiNet sub-layer 140. Yet for another example, the bridge capability indication can be a bit within an application specific information element that is logically sent from WiNet sub-layer 140 to WiNet sub-layer 240.

The DRP timeslots are allocated at the MAC layer level.

Examples of devices and bridges that have a PHY layer are illustrated in the following U.S. patent applications, all being incorporated herein by reference: U.S. patent application Ser. No. 10/389,789 filed on Mar. 10, 2003 and U.S. patent application Ser. No. 10/603,372 filed on Jun. 25, 2003.

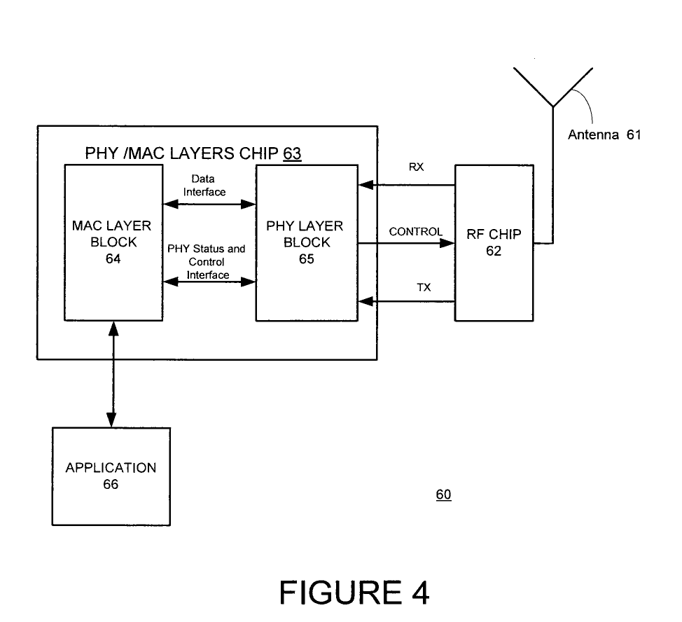

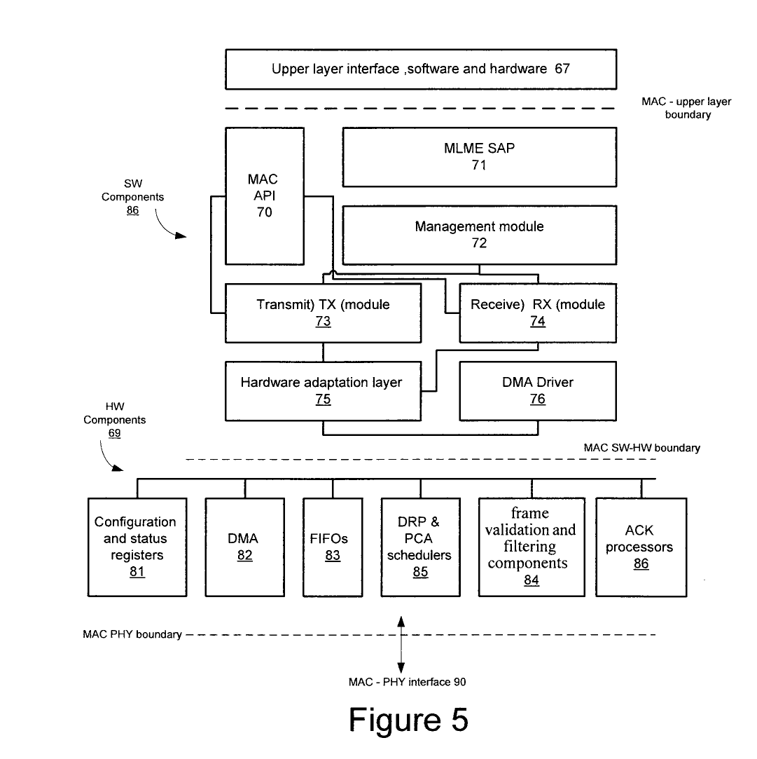

The receiver can include various components that are arranged in multiple layers. A first configuration includes a frame convergence sub-layer, a MAC layer, a PHY layer as well as MAC SAP, PHY SAP, frame convergence sub-layer SAP and a device management entity can also be utilized. Another configuration is described at FIGS. 4 and 5.

Wisair Inc. of Tel Aviv Israel manufactures a chip set that includes a Radio Frequency PHY layer chip and a Base-Band PHY layer chip. These chips can be connected in one end to a RF antenna and on the other hand be connected or may include a MAC layer circuitry.

FIG. 4 illustrates a device 60 that is capable of wireless transmission, according to an embodiment of the invention.

Device 60 includes antenna 61 that is connected to a RF chip 62. RF chip 62 is connected to a MAC/PHY layers chip 63 that includes a PHY layer block 63 and a MAC layer block 64. The MAC/PHY layers chip 63 is connected to an application entity 66 that provides it with information to be eventually transmitted (TX) and also provides the application 66 with information received (RX) by antenna 61 and processed by PHY and MAC layers blocks 68 and 69 of FIG. 5. It is noted that these chips can be at least partially integrated and that the functionality of each chip can differ from the functionality illustrated in FIG. 4 or FIG. 5.

PHY/MAC layers chip 63 as well as RF chip 62 and antenna 61 can belong to transmitter 15, transmitter 115, receiver 13 and receiver 113. PHY layer block 65, RF chip 62 and antenna service PHY layers such as PHY layer 120 and PHY layer 220. MAC layer block 64 can service MAC layer 130 and MAC layer 230.

Typically, the MAC layer block 64 controls the PHY layer block using a PHY status and control interface. The MAC and PHY layers exchange information (denoted TX and RX) using PHY-MAC interface 90. The RF chip 62 provides to the PHY layer block 63 received information that is conveniently down-converted to base band frequency. The RF chip 62 receives from the PHY layer block 63 information to be transmitted as well as RF control signals. The application 66 is connected to the MAC/PHY layers chip 63 by a high-speed I/O interface.

FIG. 5 illustrates various hardware and software components of the MAC/PHY layers chip 63, according to an embodiment of the invention.

The Upper Layer IF block 64 of the MAC/PHY layers chip 63 includes hardware components (collectively denoted 69) and software components (collectively denoted 68). These components include interfaces to the PHY layer (MAC-PHY interface 90) and to the application (or higher layer components).

The hardware components 69 include configuration and status registers 81, Direct Memory Access controller 82, First In First Out (FIFO) stacks 83 and frame validation and filtering components 84, DRP and PCA slots schedulers 85, ACK processors 86, and MAC-PHY internal interface 87.

The software components 68 include a management module 72, transmit module 73, receive module 74 hardware adaptation layer 75, DMA drivers 76, MAC layer management entity (MLME) service access point (SAP) 71, MACS API 70 and the like.

These software and hardware components are capable of performing various operations and provide various services such as: providing an interface to various layers, filtering and routing of specific application packets sent to MAC data queues or provided by these queues, performing information and/or frame processing, and the like.

The routing can be responsive to various parameters such as the destinations of the packets, the Quality of Service characteristics associated with the packets, and the like.

The processing of information along a transmission path may include: forming the MAC packet itself, including MAC header formation, aggregation of packets into a bigger PHY PDU for better efficiency, fragmentation of packets for better error rate performance, PHY rate adaptation, implementation of Acknowledgements policies, and the like. The processing of information along a reception path may include de-aggregation and/or de-fragmentation of incoming packets, implementation of acknowledgment and the like.

The hardware components are capable of transferring data between MAC software queues and MAC hardware (both TX and RX), scheduling of beacons slots, scheduling of DRP and PCA access slots, validation and filtering (according to destination address) of incoming frames, encryption/decryption operations, low-level acknowledgement processing (both in the TX path and in the RX path),

Device 60 can be a simple device or even a complex device such as but not limited to a multimedia server that is adapted to transmit information frames of different types to multiple devices. It can, for example transmit streaming data, like voice, Video, Game applications, and the like. Data files during DRP slots, and while PCA slots transmit video over IP frames, download MP3 files, download MPEG-2 files, and stream or download MPEG-4 streams.

Usually, voice frames are associated with higher quality of service requirements and accordingly are given higher transmission priorities. The voice frames QoS requirements are followed by video frames that in turn are followed by lower quality of service requirements (lower priority transmission) frames such as best effort frames and background frames.

The following tables illustrate exemplary control fields. These control fields can be sent from device (such as device 10) to bridge 100 or from bridge 100 to device, 10, according to their content. It is noted that other control fields can be used without departing from the scope of the invention.

TABLE 1 illustrates a request to allocate multiple downstream timeslots. The request includes a MUX header, a control subtype field that includes a value that indicates that the control frame is a request (this value is denoted “DRP establishment request”), expected transmission parameters (also referred to as expected traffic quality of service requirements or transmission parameters) and traffic filtering parameters (also referred to as filtering parameters). It is noted that the filtering parameters can be regarded as belonging to the transmission parameters

TABLE 1
Request

| | | | |
|---|---|---|---|
| MUX Header | Control subtype field = | Traffic | Traffic filtering |
| | DRP request | parameters | parameters |

It is noted that the control subtype field can have other values. For example it can indicate that a control frame is a response to the bridge to the request, can indicate that the control frame includes bridge capability indication, and the like.

TABLE 2 illustrates exemplary traffic parameters. It is noted that other traffic parameters can be used, for example DRP MAS parameters.

TABLE 2
Traffic parameters

| | | | | | | |
|---|---|---|---|---|---|---|
| Mean | Peak | Maximum | Maximum | Minimum | Maximum | Service |
| Data | Data | Burst Size | MSDU Size | Policed | Service | type |
| Rate | Rate | | | Unit | Interval | |

The traffic parameters include a Mean Data Rate field, a Peak Data Rate field, a Maximum Burst Size field, a Maximum Media Access Control Service Data Unit (MSDU) size field, a Minimum Policed Unit field, a Maximum Service Interval field and a Service Type Field.

The Mean Data Rate field indicates the average data rate in units of octets per second for the expected downstream traffic to the device. The Peak Data Rate field indicates the maximum expected data rate in units of octets per second, for the expected downstream traffic to the device. Conveniently, the Mean Data Rate and the Peak Data Rate values do not include the MAC and PHY overheads incurred in transferring the MSDUs.

The Maximum Burst Size field indicates the maximum burst, in units of octets, of the MSDUs belonging to the expected downstream traffic to the device that arrives to the bridge at the Peak Data Rate. The Maximum MSDU Size field indicates an unsigned integer that specifies the maximum size, in octets, of MSDUs belonging to the expected downstream traffic to the device. The Minimum Policed Unit field indicates the minimal size, in units of octets, of MSDUs belonging to the traffic expected. The Max Service Interval field indicates the required Max Service interval for the expected downstream traffic to the device, traffic expected.

The Service Type field can indicate various aspects of the downstream traffic such as acknowledgement policy (for example, no acknowledgment, immediate acknowledgement, block based acknowledgement), type of traffic (best effort, guaranteed delivery, non-guaranteed high reliability of delivery) and the like. The type of traffic is also referred to loss of sensitivity.

The filtering parameters can start by a field indicating the number of filter parameters and then the parameters of each filter are provided. Conveniently, if a frame is not blocked by either filter is can be downstream transmitted to the device.

The filtering can be applied on various control fields included within the downstream traffic that reaches the bridge. Usually, the filtering parameters include filter parameters that comprise filter length, location of filtered field in a frame, expected value of filtered field and filter mask value. Conveniently, the mask is defined on a bit-to-bit basis.

TABLE 3 illustrates an initial response to a request to allocate multiple downstream timeslots. This initial request may include error fields. It does not indicate which are the allocated downstream timeslots. The initial response includes a MUX header field, a control subtype field that includes a value that indicates that the control frame is an initial response (this value is denoted “Initial response”), and a response bitmap.

TABLE 3
Initial response

| | | |
|---|---|---|
| MUX Header | Control Subtype - Initial | Response bitmap |
| | response | |

The response bitmap includes an unsupported capability bit, an invalid acknowledgement policy bit, an invalid type of traffic bit, an invalid filtering parameters bit an unsupported filtering parameter bit and additional bits such as security violation bit, resource limitation bit and the like.

The unsupported capability bit is the bridge capability indication and indicates if the bridge can allocate downstream timeslot in response to a request from the device. The invalid acknowledgement policy bit indicates if the request included a request to apply an invalid acknowledgement policy. The invalid type of traffic bit indicates if the request included a request to apply an invalid type of traffic. The invalid filtering parameters bit and the unsupported filtering parameter bit indicate if the request included a request to support invalid or unsupported type of traffic. Examples of erroneous requests can include a request to support multicast and immediate or block based acknowledgement; filtering parameters that include a communication protocol that is not covered by the request, too many filtering parameter sets, and the like.

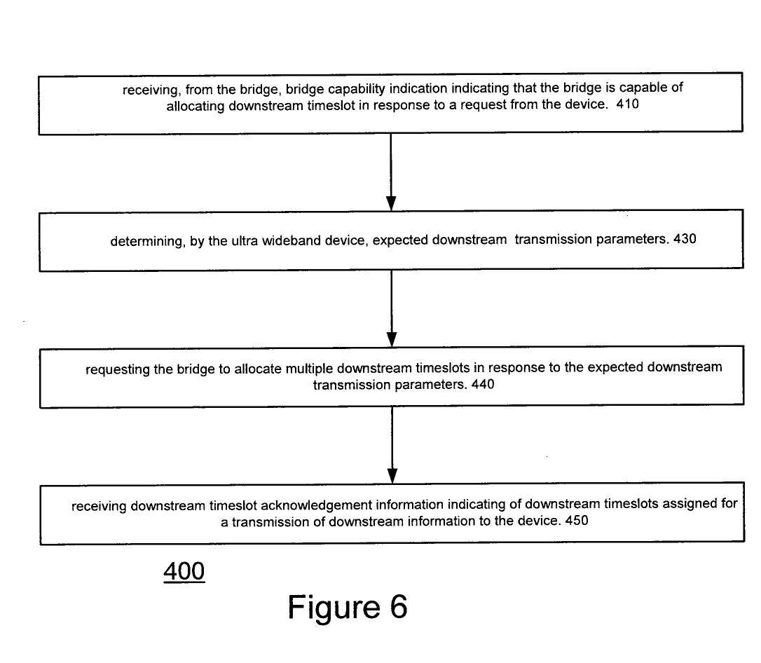

FIG. 6 is a flow chart of method 400, according to an embodiment of the invention.

Method 400 starts by stage 410 of receiving, from the bridge, bridge capability indication indicating that the bridge is capable of allocating downstream timeslot in response to a request from the device. If the bridge does not have such a capability method 400 ends.

Stage 410 is followed by stage 430 of determining, by the ultra wideband device, expected downstream transmission parameters. These parameters can relate to expected quality of service level associated with the downstream transmission.

Conveniently, stage 430 includes converting high communication layer quality of service characteristics to expected media access control downstream transmission parameters.

Stage 430 is followed by stage 440 of requesting the bridge to allocate multiple downstream timeslots in response to the expected downstream transmission parameters. It is noted that stage 440 can be followed by another stage of receiving an initial response from the bridge and correcting the request (if necessary) in response to the initial response. For example the acknowledgement policy can be altered and the like.

Stage 440 is followed by stage 450 of receiving downstream timeslot reservation request on the MAC layer, indicating of downstream timeslots assigned for a transmission of downstream information to the device.

In case the reservation is established successfully, Stage 450 is followed by stage 460 of receiving downstream information during the assigned downstream timeslots.

Conveniently, stage 430 includes determining filtering parameters for filtering downstream information to be provided to the device. The filtering parameters can include multiple filter parameters defining multiple filters. Conveniently, the filtering parameters include filter length, location of filtered field in a frame, expected value of filtered field and filter mask value.

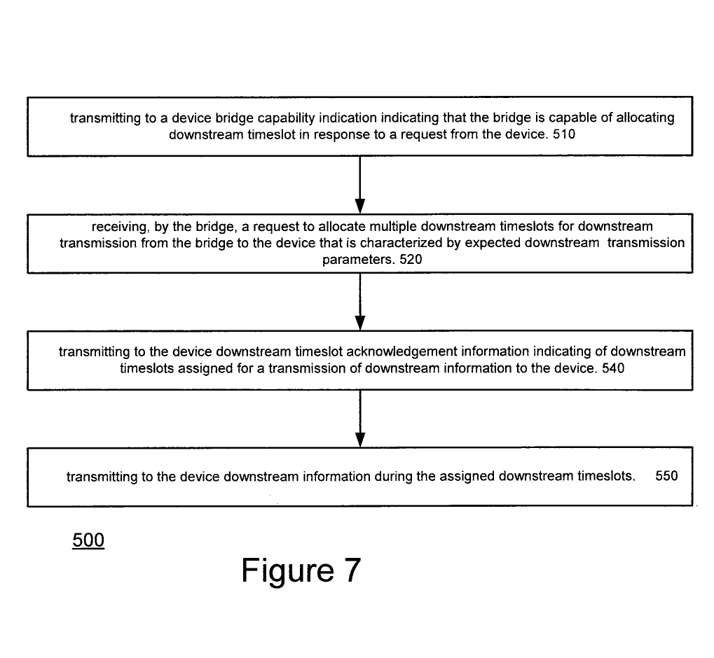

FIG. 7 is a flow chart of method 500, according to an embodiment of the invention.

Method 500 starts by stage 510 of transmitting to a device bridge capability indication indicating that the bridge is capable of allocating downstream timeslot in response to a request from the device.

Stage 510 is followed by stage 520 of receiving, by the bridge, a request to allocate multiple downstream timeslots for downstream transmission from the bridge to the device that is characterized by expected downstream transmission parameters. These downstream transmission parameters can indicate the quality of service associated with the device.

Stage 520 can be followed by examining the request and sending an initial response that may indicate that the requests include errors.

Stage 520 is followed by stage 540 of transmitting to the device downstream timeslot acknowledgement information indicating of downstream timeslots assigned for a transmission of downstream information to the device. Stage 540 may include issuing a DRP reservation request of downstream timeslots in response to the device DRP establishment request and then receiving an acknowledgement indicating which timeslots should be allocated to the device.

Stage 540 is followed by stage 550 of transmitting to the device downstream information during the assigned downstream timeslots.

Conveniently, stage 550 includes filtering downstream information in response to filtering parameters provided by the device.

It will be apparent to those skilled in the art that the disclosed subject matter may be modified in numerous ways and may assume many embodiments other then the preferred form specifically set out and described above. It is noted that each of the mentioned above circuitries can be applied by hardware, software, middleware or a combination of the above. The mentioned above methods can be stored in a computer readable medium, such as but not limited to tapes, disks, diskettes, compact discs, and other optical and/or magnetic medium.

Accordingly, the above disclosed subject matter is to be considered illustrative and not restrictive, and to the maximum extent allowed by law, it is intended by the appended claims to cover all such modifications and other embodiments, which fall within the true spirit and scope of the present invention.

The scope of the invention is to be determined by the broadest permissible interpretation of the following claims and their equivalents rather then the foregoing detailed description.

We claim:

1. A method for exchanging information between an ultra wideband device and a bridge over a wireless medium, the method comprising: determining, by the ultra wideband device, expected downstream transmission parameters; requesting the bridge to allocate multiple downstream timeslots in response to the expected downstream transmission parameters; receiving downstream timeslot acknowledgement information indicating of downstream timeslots assigned for a transmission of downstream information to the device; receiving downstream information during the assigned downstream timeslots.

2. The method according to claim 1 wherein the transmission parameters comprise filtering parameters for filtering downstream information to be provided to the device.

3. The method according to claim 2 wherein the filtering parameters comprise multiple filter parameters defining multiple filters.

4. The method according to claim 2 wherein the filtering parameter comprises a filter parameters that comprise filter length, location of filtered field in a frame, expected value of filtered field and filter mask value.

5. The method according to claim 1 further comprising receiving, from the bridge, bridge capability indication indicating that the bridge is capable of allocating downstream timeslot in response to a request from the device.

6. The method according to claim 1 wherein the determining comprises converting high communication layer quality of service characteristics to the expected media access control downstream transmission parameters.

7. A method for exchanging information between a ultra wideband device and a bridge over a wireless medium, the method comprising: receiving, by the bridge, a request to allocate multiple downstream timeslots for downstream transmission from the bridge to the device that is characterized by expected downstream transmission parameters; scheduling downstream timeslots in response to the request; transmitting to the device downstream timeslot reservation information indicating of downstream timeslots assigned for a transmission of downstream information to the device, and establishing a DRP reservation with a device as a result; transmitting to the device downstream information during the assigned downstream timeslots.

8. The method according to claim 7 wherein the transmission parameters comprise filtering parameters for filtering downstream information to be provided to the device.

9. The method according to claim 8 further comprising filtering frames before being sent to the device.

10. The method according to claim 7 further comprising transmitting to the device bridge capability indication indicating that the bridge is capable of allocating downstream timeslot in response to a request from the device.

11. An ultra wideband wireless device, the device comprises: a controller adapted to determine expected downstream transmission parameters; and a receiver; wherein the device is adapted to request a bridge to allocate multiple downstream timeslots in response to the expected downstream transmission parameters; wherein the receiver is adapted to receive downstream timeslot reservation information indicating of downstream timeslots assigned for a transmission of downstream information to the device; and to receive downstream information during the assigned downstream timeslots.

12. The ultra wideband wireless device according to claim 11 wherein the controller is adapted to determine transmission parameters that comprise filtering parameters for filtering downstream information to be provided to the device.

13. The ultra wideband wireless device according to claim 12 wherein controller is adapted to determine transmission parameters that comprise multiple filter parameters defining multiple filters.

14. The ultra wideband wireless device according to claim 12 wherein the controller is adapted to determine transmission parameters that comprise filter length, location of filtered filed in a frame, expected value of filtered field and filter mask value.

15. The ultra wideband wireless device according to claim 11 wherein the device is adapted to generate the request if it receives, from the bridge, bridge capability indication indicating that the bridge is capable of allocating downstream timeslot in response to a request from the device.

16. The ultra wideband wireless device according to claim 111 wherein the controller is adapted to convert high communication layer quality of service characteristics to the expected media access control downstream transmission parameters.

17. An ultra wideband bridge, the ultra wideband bridge comprises a receiver, a transmitter and a controller, wherein the receiver is adapted to receive a request to allocate multiple downstream timeslots for downstream transmission from the bridge to the device that is characterized by expected downstream transmission parameters; wherein the controller is adapted to schedule downstream timeslots in response to the request; wherein the transmitter is adapted to transmit to the device downstream timeslot reservation information indicating of downstream timeslots assigned for a transmission of downstream information to the device, and establish as a result the DRP time-slots, and to transmit to the device downstream information during the assigned downstream timeslots.

18. The ultra wideband bridge according to claim 17 wherein the controller is adapted to filter information that is downstream transmitted to the device in response to filtering parameters received by the receiver.

19. The ultra wideband bridge according to claim 17 wherein the transmitter is adapted to transmit to the device bridge capability indication indicating that the bridge is capable of allocating downstream timeslot in response to a request from the device.

20. The ultra wideband bridge according to claim 17 wherein the controller is adapted to participate in a distributed media access control scheme in order to schedule the downstream timeslots.
